(19) United States
(12) Patent Application Publication
(10) Pub. No.: US 2025/0328567 A1
(43) Pub. Date: Oct. 23, 2025

(54) METHOD FOR AUGMENTED COMPONENT SEARCH UTILIZING STRUCTURED AND UNSTRUCTURED DATASHEET DATA

(71) Applicant: Wizerr, Inc., San Jose, CA (US)

(72) Inventors: Onzali Suba, San Francisco, CA (US); Avinash Harsh, San Jose, CA (US)

(21) Appl. No.: 19/187,177

(22) Filed: Apr. 23, 2025

Related U.S. Application Data
(60) Provisional application No. 63/637,593, filed on Apr. 23, 2024.

(51) Int. Cl. G06F 16/334; G06F 16/332; G06F 16/3329; G06F 16/338

(52) U.S. Cl. CPC G06F 16/3347; G06F 16/3326; G06F 16/33295; G06F 16/338

(57) ABSTRACT

A method for AI-driven natural language search includes receiving a user query for one or more items from a user, processing the user query by searching against at least one relational database associated with the query, where the relational database is generated by extracting features from electronic documents of a plurality of items associated with the one or more items and by identifying specifications or respective values corresponding to the extracted features of the plurality of items, generating one or more query results based on the processing of the user query, where the one or more results include at least one item identified from the plurality of items and a justification for explaining an irrelevance of the at least one item, and transmitting the one or more query results to a user device for presentation to the user.

### CROSS-REFERENCE TO RELATED APPLICATION

This application claims the benefit of and priority to U.S. Provisional Patent Application No. 63/637,593 filed on Apr. 23, 2024, the entire application of which is hereby incorporated by reference in its entirety for all purposes.

### TECHNICAL FIELD

This disclosure generally relates to the field of information retrieval and data mining technology, and more particularly to an enhanced natural language search and retrieval method and system tailored for effectively searching and extracting relevant technical data from complex and diverse sources.

### BACKGROUND

Extracting relevant technical information from complex sources, such as product datasheets, has long posed a significant challenge for industries and enterprises. These datasheets often include a wide range of content, such as unstructured text, tables, images, graphics, multimedia, and the like, making data retrieval difficult. Traditional information retrieval methods, which primarily depend on keyword-based searches or Boolean logic, often fall short in accurately locating specific technical details embedded within these varied formats.

The shortcomings of conventional search techniques become even more apparent in highly specialized technical fields that demand nuanced queries. Datasheets frequently use domain-specific jargon, abbreviations, and terminology that vary widely between manufacturers and suppliers. Users seeking components that meet precise technical specifications, such as memory size, clock frequency, or thermal limits like operating and storage temperature, need advanced search tools capable of understanding the semantics and context of their queries. Unfortunately, existing systems lack the depth to deliver such context-aware, accurate search experiences.

Additionally, search results for technical data should be easily interpretable and provide clear reasoning for why a product meets a user's criteria. Merely listing product names or IDs is often insufficient. Users increasingly expect natural language explanations that clarify how and why certain components match their requirements. These explanations not only improve transparency and user trust but also streamline decision-making in data-driven industrial workflows. Y et, most current systems fail to provide this level of interpretability in their search outputs.

The foregoing discussion, including the description of motivations for some embodiments, is intended to assist the reader in understanding the present disclosure, is not admitted to be prior art, and does not in any way limit the scope of any of the claims.

### SUMMARY OF THE DISCLOSURE

To address the aforementioned shortcomings and other problems in the existing user query processing, a method and system for AI-driven natural language search are provided. Briefly, the method for AI-driven natural language search includes receiving a user query for one or more items from a user, processing the user query by searching against at least one relational database associated with the query, where the relational database is generated by extracting features from electronic documents of a plurality of items associated with the one or more items and by identifying specifications or respective values corresponding to the extracted features of the plurality of items, generating one or more query results based on the processing of the user query, where the one or more results include at least one item identified from the plurality of items and a justification for explaining an irrelevance of the at least one item, and transmitting the one or more query results to a user device for presentation to the user.

The above and other preferred features, including various novel details of implementation and combination of elements, will now be more particularly described with reference to the accompanying drawings. It will be understood that the particular methods and/or apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present application, illustrate the presently preferred embodiments and together with the general description given above and the detailed description of the preferred embodiments given below serve to explain and teach the principles described herein.

FIG. 1 is a block diagram of an example AI-driven natural language search system, in accordance with some embodiments.

FIG. 2 illustrates example components included in an AI-driven natural language search application, in accordance with some embodiments.

FIG. 3 illustrates an example conceptual flow diagram that outlines a process for extracting structured data from technical documents, in accordance with some embodiments.

FIG. 4 illustrates an example comprehensive query processing framework designed to intelligently handle user queries, in accordance with some embodiments.

FIG. 5 illustrates an example conceptual flow diagram for handling a user query, in accordance with some embodiments.

FIG. 6 is a flow chart of an example method for augmented component search utilizing structured and unstructured datasheet data, in accordance with some embodiments.

FIG. 7 is a block diagram of an example computer system, in accordance with some embodiments.

It will be appreciated that, for simplicity and clarity of illustration, where considered appropriate, reference numerals may be repeated among the figures to indicate corresponding or analogous elements.

### DETAILED DESCRIPTION

The present disclosure describes software-based methods and systems for AI-driven processing of natural language queries about electronic documents in structured and unstructured formats. The Figures (FIGS.) and the following description relate to preferred embodiments by way of illustration only. It should be noted that from the following discussion, alternative embodiments of the systems and methods disclosed herein will be readily recognized as viable alternatives that may be employed without departing from the spirits and principles of the disclosure.

### Motivation and Benefits

As described earlier, in technical and industrial settings, product selection and component matching often hinge on the accurate interpretation of datasheets. These datasheets are inherently complex, incorporating a mix of structured and unstructured data such as textual descriptions, technical tables, diagrams, and images. Traditional search methods that rely on simple keyword matching or Boolean logic struggle to cope with this complexity. They are typically unable to identify and retrieve precise technical information, especially when it is expressed in varying formats or terminologies across different manufacturers and suppliers.

This problem becomes more critical in specialized domains, where users submit highly specific and nuanced queries using industry-specific jargon or abbreviations. The lack of systems capable of semantically understanding and contextualizing these queries leads to inaccurate or irrelevant results. Additionally, current search tools rarely provide clear justifications or explanations for their recommendations, leaving users with little confidence in the search results. This hampers transparency and prolongs the decision-making process, particularly in environments where speed and accuracy are paramount.

The present disclosure addresses these limitations by introducing a robust, artificial intelligence (AI)-driven search system that enhances both the accuracy and transparency of technical data retrieval. One of its primary benefits is its ability to interpret complex natural language queries and convert them into multiple search strategies, including full-text, vector-based semantic, and structured SQL search. This hybrid approach ensures that the system can capture both exact matches and semantically relevant results, dramatically improving search accuracy and relevance.

Moreover, the technical solution disclosed herein transforms raw datasheet content into standardized, structured formats, enabling efficient storage and rapid access using relational databases. The data pipeline, from extraction using tools like Azure® AI Document Intelligence to transformation and storage, supports large-scale implementation and ensures consistency across diverse datasheet formats.

Another key advantage of the disclosed solution is the system's ability to explain its recommendations. By generating natural language justifications for each retrieved result, it helps users understand why a particular product fits their query, fostering trust and aiding quicker decisions. Users can also interact with datasheets in a conversational manner, thanks to the integration of retrieval-augmented generation (RAG) techniques. This allows them to “chat” with the content, including images and diagrams, extracting insights that go beyond text alone.

Additionally, the disclosed technical solution incorporates human feedback into its loop, enabling the models to adapt and improve over time. This feedback mechanism allows for dynamic learning and refinement, ensuring sustained relevance and effectiveness. Accordingly, the system streamlines complex product selection processes, reduces manual effort, enhances interpretability, and offers a comprehensive and intelligent interface for exploring technical documents, leading to significant time and resource savings for relevant entities.

It is to be understood that the benefits and advantages described herein are not all-inclusive, and many additional features and advantages will be apparent to one of ordinary skill in the art in view of the figures and the following descriptions.

### System Architecture

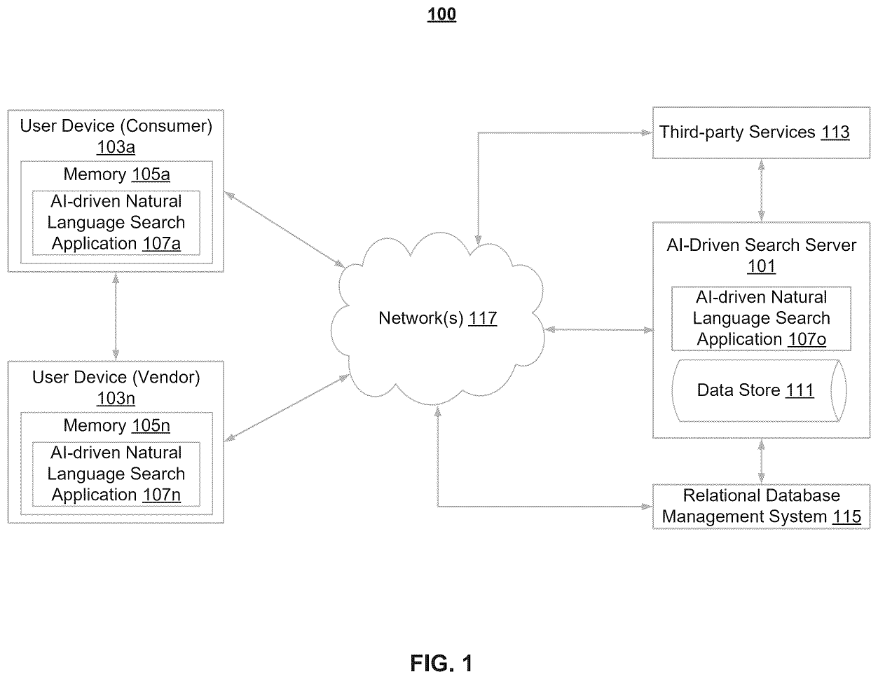

FIG. 1 is a block diagram of an example AI-driven natural language search system 100, in accordance with some embodiments. The AI-driven natural language search system 100 may be a network-based specialized computer environment for processing natural language user queries using one or more AI-driven models, including using the AI-driven models to preprocess and extract the user queries so as to implement a multi-method search when executing the user queries. In the following descriptions, datasheets in PDF format or from a website are used to explain the technical solutions provided by the present disclosure. However, it should be noted that the disclosed method and system are not limited to such applications but rather can be applied to querying electronic documents in any format and from any source.

As illustrated in FIG. 1, the AI-driven natural language search system 100 may include multiple user devices 103a . . . 103n, which may be specialized computers or other machines that are configured to provide user interfaces for users to interact with an AI-driven natural language search application installed on the user devices and server (e.g., AI-driven natural language search application 107a/107n installed on the memory 105a/105n of the user device 103a/103n and AI-driven natural language search application 1070 installed on an AI-driven search server 101). In one example, the multiple user devices 103a . . . 103n may include a user device (e.g., user device 103a) for a consumer interested in certain products and a user device (e.g., user device 103n) for a vendor (e.g., a seller or a producer) for providing products. The consumer may hope to know more about a product provided by the vendor, and thus may generate a query, through the AI-driven natural language search application 107a, about the product or a number of products related to the product (e.g., different models of a laptop, or even different brands from different vendors). The vendor may generate, through the AI-driven natural language search application 107n, a query result in response to the user query. In some embodiments, the query result generated by the AI-driven natural language search application 107n may be achieved through cooperation with the AI-driven natural language search application 1070 installed on the AI-driven search server 101. In some embodiments, an AI-driven natural language search application 107a may be not installed on the consumer device 103a, and the consumer may submit a user query directly through the AI-driven natural language search application 107n (e.g., through a user interface provided through a website).

As will be described in detail later, the AI-driven natural language search application 107a/107n on the user device 103a/103n may be configured to focus more on user interactions such as receiving user queries and presenting responses to the users related to the queries, while the AI-driven natural language search application 1070 in the AI-driven search server 101 is configured to focus more on the query execution and generating responses to the user queries, including generating justifications for the query results, as will be described in detail later. In some embodiments, a user device 103 may be a part of distributed computing topology, which brings certain early stages of processing to the devices where data is being gathered, rather than relying all on a central location (e.g., AI-driven search server 101) that can be thousands of miles away. In one example, the early stage of preprocessing and extraction of the user queries may be executed on the user device (e.g., user device 103n), which can be then forwarded to the remote server 101 for further query execution.

According to some embodiments, the AI-driven search server 101 may be configured to have a higher computation power than the user devices 103, and thus some intensive data computations such as query execution and justification generation may be implemented on the server 101, which saves the computation resources and/or reduces the requirement for computation power of each specific user device 103. In some embodiments, the AI-driven search server 101 may be a single server or a sever cluster. For example, the AI-driven search server 101 may include one server to store user queries and responses and other interactions, which may further forward the user queries to another server with a higher compute with GPU to actually break down of the natural language to the right specifications and perform a next set of processes, such as generating the responses and justifications. In some embodiments, the AI-driven search server 101 may be separately housed from other devices within the AI-driven natural language search system 100, such as user devices 103. Alternatively, an AI-driven search server 101 may be part of a device or system, e.g., may be integrated with a user device 103n associated with a vendor to form an integrated device of the AI-driven natural language search system 100. In additional embodiments, the various functions for the AI-driven natural language search application 107 disclosed elsewhere may be partially or completely executed in any one of the user device 103 or server, which is not limited in the present disclosure.

In some embodiments, the AI-driven search server 101 and the user devices 103 may collaborate with certain third-party services 113 when processing the natural language user queries. The third-party services 113 may include certain AI-driven natural language processing tools that may be used by the server 101 and/or user device 103 for extracting data and information from the user queries and from datasheets related to the products. The third-party services 113 may also include certain AI-driven tools that generate certain summaries for the items included in the query results, as will be described in detail later. In some embodiments, the computers, servers, and/or systems that make up the third-party services 113 are different from a user or an organization's own on-premises computers, servers, and/or systems. In some embodiments, services provided by the third-party services 113 may include a host of services that are made available to users of the cloud infrastructure system on demand. For example, the services provided by the third-party services 113 may additionally include, but are not limited to, machine learning model development, training, and deployment, messaging, social networking, data processing, image processing, audio-to-voice conversion, video-to-voice conversion, emailing services, intelligent analytics, Software as a service (Saas), conversational artificial intelligence (AI), prompt generation, prompt modification, or any other services accessible to online users or user devices. In some embodiments, the third-party services 113 may be utilized by the AI-driven search server 101 or the user device 103 as a part of the extension of the server or user device, e.g., through a direct connection to the server or through a network-mediated connection or through direct installation of such tools in the server or user device.

In some embodiments, the AI-driven natural language search system 100 may further include a relational database management system 115, which is configured to manage relational databases generated during the user query processing. For example, the datasheets for products from the vendor or other sources may be processed through data extraction to identify features and specifications, which may be stored in the relational databases for easier data query, as will be described in detail later. The relational database management system 115 may also store relational data obtained through other different means or for other different purposes. In some embodiments, each of the user devices 103 and AI-driven search server 101 may optionally include their own data store (e.g., data store 111 for the server) for storing any data required and generated in the processes related to the functions of these components.

In some embodiments, different components in the system 100 may communicate with each other through a data communication interface(s). For example, the user devices 103 may collect and send user queries or datasheets to the AI-driven search server 101 to be processed therein, and/or may send signals to the AI-driven search server 101 to control different aspects of the data the server is processing, among other possibilities. The user devices 103 may interact with the AI-driven search server 101 through several ways, for example, over one or more networks 117.

The networks 117 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a wireless network may include a short-range communication channel, such as Bluetooth or a Bluetooth low-energy channel. A wired network may include a wired interface. The wired and/or wireless networks may be implemented using routers, access points, bridges, gateways, or the like, to connect devices in the system 100. The one or more networks 117 may be incorporated entirely within or may include an intranet, an extranet, or a combination thereof. In one embodiment, communications between two or more systems and/or devices may be achieved by a secure communications protocol, such as a secure sockets layer or transport layer security.

It should be also noted that, while various user devices, servers, and services units are illustrated in the AI-driven natural language search system 100 in FIG. 1, it will be appreciated that more or fewer components may be used instead.

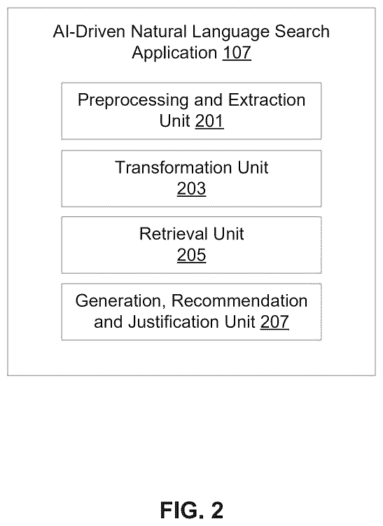

FIG. 2 illustrates example units included in an AI-driven natural language search application 107, in accordance with some embodiments. As illustrated in the figure, the AI-driven natural language search application 107 may include a preprocessing and extraction unit 201, a transformation unit 203, a retrieval unit 205, and a generation, recommendation and justification unit 207. These different units 201-207 may be coupled to each other to collaboratively achieve the AI-natural language searching as further described in detail below.

The preprocessing and extraction unit 201 may be configured to preprocess and extract raw data from datasheets, which may contain structured and unstructured data formats, including but not limited to text, images, and tables. In some embodiments, to perform this task efficiently, the preprocessing and extraction unit 201 may leverage certain AI-supported data extraction tools, such as Azure® AI Document Intelligence, Azure® Computer Vision API, Azure® Form Recognizer, and Tesseract®, among others. These tools may enable the automated extraction of key elements such as tables and paragraphs from datasheets. In some embodiments, the extracted tables and paragraphs may be further passed to certain AI-supported data analysis tools, such as Open AI® APIs (e.g., GPT-4®) or Claude® from Anthropic or a fine-tuned model to identify relevant searchable features and specifications from the datasheet, as will be described in detail below. A fine-tuned model disclosed herein means that the model is trained further with domain-specific examples (e.g., thousands of datasheets) to understand exactly how to interpret technical documents.

In some embodiments, the output of the AI-supported data extraction tool (such as Azure® AI Document Intelligence for pdfs that are largely images or a specifically configured extraction pipeline including a combination of python libraries for textual pdf extraction) may be not readily usable due to formatting and/or content complexity. To address this, the preprocessing and extraction unit 201 may be configured to isolate and separate distinct data types, such as tables and paragraphs, from the initial extraction output, and may handle these types of data differently.

For example, when data is extracted from datasheets, especially technical ones, it often includes tables filled with specifications, feature lists, performance metrics, and more. However, these tables may appear in a variety of inconsistent formats, particularly when they originate from PDFs or scanned documents. This inconsistency makes it difficult for AI models to interpret the data reliably. To address this, the tables isolated by the preprocessing and extraction unit 201 may be converted into HyperText Markup Language (HTML) format. HTML provides a well-defined structure for representing tables: it clearly distinguishes between headers, rows, and cells. For example, a product specification table in HTML would neatly separate the feature names from their corresponding values, just like one would see on a website. This structured formatting is extremely helpful when using prompt engineering techniques with large language models (LLMs) like GPT-4®, since LLMs generally perform better when the input data is presented in a consistent and semantically rich format. When an LLM model sees a clean, labeled table, such as HTML, the model may more easily recognize patterns, such as feature-value pairs. This leads to a more accurate extraction of technical specifications, like memory capacity, voltage ranges, or thermal thresholds. Additionally, HTML may allow one to highlight or tag important elements, guiding the model to focus on relevant parts. For example, if a user wants the model to only extract specifications from a certain section, the user may isolate that section using HTML classes or IDs. Accordingly, converting tables to HTML acts as a preprocessing step that bridges the gap between messy raw data and precise AI interpretation, making the entire extraction pipeline more effective and reliable.

In alternative embodiments, to accurately extract structured tabular data from PDF datasheets, the system may utilize a hybrid approach combining img2table and Azure AI extraction services. Although the name img2table might suggest that it only processes image-based tables, it's actually capable of handling textual content from PDFs as well. In practice, the tool is applied not just to extract data from embedded images, but more importantly, to process the raw text layout of tables within PDF files, ensuring that the table structure, such as row and column alignment, is properly retained during conversion. The process may begin by feeding the textual content of the PDF into img2table, rather than actual images. This step is crucial because many PDFs, especially those generated digitally (not scanned), contain textual table layouts that need to be interpreted spatially. Img2table is adept at detecting table boundaries, headers, and cells from this text structure, which allows it to reconstruct the table layout in a way that mimics the original design in the PDF. To enhance this further, Azure AI Document Intelligence or other similar tools are employed, particularly its table extraction models, which may validate or supplement the extracted content, providing high fidelity in detecting merged cells, header hierarchies, and column relationships. Once the tables are extracted and validated, they are converted into Pandas DataFrames, a powerful tabular data structure in Python widely used for analysis and transformation. These DataFrames may provide a clean, programmatic way to access each cell, row, and column of the table. More importantly, they enable LLMs, such as GPT-4®, to interpret and extract specifications more accurately. With the tables now in structured form, LLMs can easily identify feature-specification pairs, compare rows, and apply semantic understanding to complex specifications, something that would be much more error-prone if operating on unstructured or poorly parsed text. This structured extraction pipeline is particularly valuable in technical domains, where the layout and hierarchy of data in tables carry significant meaning. By preserving the exact structure and converting the tables into Pandas format, the system may ensure that downstream AI models can work with the data in a context-aware and scalable manner, leading to more precise feature extraction and product comparison.

In some embodiments, the preprocessing and extraction unit 201 may employ prompt engineering to effectively design and improve prompts to get better results on different tasks with LLMs, for example, to extract the aforementioned list of specifications. Prompt engineering is the practice of carefully designing and refining the instructions (or “prompts”) given to an LLM, like Anthropic®, Gemini®, GPT-4® to get the best possible output for a specific task. Since LLMs rely heavily on the context, the phrasing of the input they receive and how a user asks a question or presents the data may dramatically affect the quality of the model's response. In the case of datasheet processing, the goal is often to extract a specific list of technical specifications (like fan speed, voltage, power consumption, current, voltage, topology, etc.). Prompt engineering may play a crucial role here: by framing the prompt correctly and providing the right structure or examples, the model is more likely to return accurate, relevant, and formatted data.

In some embodiments, to adapt to different types of datasheets or extraction goals, the preprocessing and extraction unit 201 may switch between various prompting techniques, each tailored for different use cases as described further. Zero-shot prompting is where a model is asked to perform a task without any examples, for example, “extract the output voltage (min/max) for the product with unit volts.” This works well if the model already understands the task. Few-shot prompting provides a prompt that includes a few examples of the desired input and output. This helps guide the model by showing it what the correct response looks like, which improves accuracy. Another example of few-shot prompting includes using function tooling to help convert data into the right units under certain circumstances. Generate knowledge prompting is used when a model needs to create or infer data, such as summarizing a complex specification sheet or synthesizing missing data based on related entries. Graph prompting is a technique that helps extract relationships between entities, which is useful for building feature-value maps or knowledge graphs from unstructured text. Chain-of-thought prompting may guide a model to “think aloud” step-by-step through a problem. For instance, to extract a complicated feature set, the model may be guided to first identify the section of interest, then locate features, and finally map them to values, improving logical reasoning and clarity in the output. In some embodiments, each of these prompting techniques may be employed by the preprocessing and extraction unit 201 to help fine-tune how a model interprets and processes the input, ensuring the extracted specifications are accurate, comprehensive, and well-structured. In some embodiments, based on the goals, the preprocessing and extraction unit 201 may use different prompting techniques to achieve specific tasks with LLMs in the present disclosure. In one specific example, few-shot prompting may be used for relation extraction aimed at learning to identify the relation between features and the respective values or specifications. The feature-value pairs may be then saved as a structured JavaScript object notation (JSON) file, which is an open standard file format and data interchange format that uses human-readable text to store and transmit data objects consisting of attribute-value pairs and/or arrays (or other serializable values).

A specific example in datasheet preprocessing and extraction is further described. Imagine a user is working with a datasheet for a graphics processing unit (GPU). The datasheet may contain a lot of technical information, often presented in tables or scattered across paragraphs. Important details include specifications like fan speed, memory capacity, core count, power consumption, and more. Now, rather than having this data stay in its original, sometimes cluttered or inconsistent format, the preprocessing and extraction unit 201 may extract these key features and their corresponding values, for example, fan speed: 2000 RPM, memory capacity: 8 GB. Each feature is then mapped to its value and organized into a structured format, e.g., a JSON file as described above. This systematic mapping by the preprocessing and extraction unit 201 may serve several purposes, including but not limited to improved searchability, comparison across models, and data integration. Specifically, instead of scanning through text, the system 100 may now directly query and retrieve data from specific fields in the JSON that is converted into a structured table. For instance, a user may search for all GPUs with more than 6 GB of memory. In addition, by using a consistent format, it's easier to compare multiple power management products side by side in a low dropout (LDO) design, e.g., identifying what specs differ or remain the same. Furthermore, structured JSON may be fed into other systems, like databases, dashboards, or recommendation engines, making it a powerful tool for automation and analytics.

In short, through preprocessing and data extraction, the preprocessing and extraction unit 201 may take a PDF file or a website containing datasheet information as the input, and produce a structured JSON file containing comprehensive extracted data as the output. In some embodiments, this extraction is being automated by the process of fine-tuning a multimodal large language model like GPT-4® or open-source models with reinforcement learning with human feedback (RLHF). Here, a fine-tuned model disclosed herein means that the model is trained further with domain-specific examples (e.g., thousands of datasheets) to understand exactly how to interpret technical documents. RLHF means that real humans evaluate how well the model is doing and provide feedback. The model then uses this feedback to improve over time, learning how to extract more accurate and meaningful data.

Referring back to FIG. 2, the AI-driven natural language search application 107 may further include a transformation unit 203 configured to transform the extracted data into a standardized format to enhance usability and accessibility across systems. In one embodiment, the transformation unit 203 may convert the JSON-formatted data into a relational format compatible with traditional relational database management systems (RDBMS), such as PostgreSQL®, Microsoft® SQL Server, Oracle® Database, MySQL, IBM @ DB2, and the like. In general, a relational database is a collection of highly structured tables, where each row reflects a data entity, and every column defines a specific information field, where rules can be further developed to link and cross-reference information, creating relationships between different data elements, making it easier to query, analyze, and maintain consistency across different datasets.

In some embodiments, the system 100 utilizes a robust and scalable database management system (DBMS), such as PostgreSQL, for storing and managing the transformed data. PostgreSQL's support for a wide range of data types, including Boolean, character, numeric, temporal, array, JSON, and vector data (via extensions such as pgvector), makes it well-suited for storing and querying the diverse and structured information extracted from electronic component datasheets, including high-dimensional embeddings.

In some embodiments, along with the extracted data, the raw text document is also saved in the database to enable full-text search. This raw text may include descriptive paragraphs, usage guidelines, or product context that isn't easily captured in a structured format. Storing this raw content is essential for enabling full-text search, allowing users to query not only structured fields but also the entire textual content of a datasheet. In some embodiments, to make this full-text search fast and efficient, the transformation unit 203 may use a generalized inverted index (GIN) to further label the raw data and/or extracted/transformed data. A GIN is a special type of index used in database systems (like PostgreSQL) that's designed for more complex data types, particularly those where each data entry might contain multiple values or elements, such as arrays, documents, or even JSON fields. In a traditional index, a system keeps a list of where each word appears in the document. In a GIN index, it goes a step further by indexing every individual element inside a compound structure, like every word in an array or sentence in a paragraph. When a user performs a search, the index helps quickly locate all instances where that word or concept appears, even if it's buried inside a complex data item. This is especially helpful when the system needs to support advanced search queries, like finding documents where a specific term appears within product descriptions, technical notes, or contextual explanations. Accordingly, by storing the raw document and indexing it with a GIN, the system may enable rich, high-performance search capabilities that can dive deep into the unstructured text, not just surface-level keywords.

In some implementations, the transformation unit 203 is further configured to convert extracted paragraphs and tables into embeddings. The transformation unit 203 may carry out the transformation using embedding models like OpenAI's ‘text-embedding-ada-002’, fine-tuned custom model, or other open-source alternatives. Embeddings are mathematical representations of text, where the meaning of the content is encoded into a multi-dimensional vector (essentially, a list of numbers). Through this transformation process, the generated embeddings may allow the system to understand the context and meaning of the content, rather than just looking at exact words. For example, the phrases “graphics card speed” and “GPU clock rate” might use different terms, but they convey similar ideas. A traditional keyword-based search system might treat them as unrelated. But with embeddings, the system can recognize their semantic similarity.

In one specific example, the transformation unit 203 may convert paragraphs and tables from a datasheet, especially those rich in technical or contextual details, into vector embeddings. These embeddings capture the deeper meaning and relationships in the text, not just the individual words.

In some embodiments, when a user performs a search, the transformation unit 203 may also convert the search query itself into an embedding. The system then compares the query's embedding with the stored embeddings using vector similarity, a mathematical method that finds the closest matches in meaning. This approach enables what's called a vector search or semantic search. Unlike keyword-based systems that only match exact terms, semantic search may understand synonyms or variations in phrasing, interpret the intent behind the query, and return more relevant and context-aware results. This is especially useful in technical domains like datasheets, where the same concept can be described in many ways depending on the manufacturer or product type.

Referring continuously to FIG. 2, the AI-driven natural language search application 107 may further include a retrieval unit 205 configured to retrieve relevant data related to datasheets in response to a user query. In some embodiments, when receiving a search query made by a user, the retrieval unit 205 may intelligently employ a multi-method search strategy to retrieve the most accurate and comprehensive results from the datasheets or structured database converted from the datasheets. The retrieval unit 205 is configured to account for the wide variety of ways users might phrase their queries and the diverse formats in which data may exist across documents. To achieve this, the retrieval unit 205 may integrate three distinct search methods, full-text search, vector-based semantic search, and SQL query translation, which may be executed either in sequence or concurrently for optimal performance.

To implement a full-text search, the retrieval unit 205 may process a user's query by removing common stop words and identifying the core keywords. The retrieval unit 205 may then scan the stored documents to find matches based on these keywords. This then ensures that relevant documents containing those terms are retrieved, even if the context isn't perfectly matched. It serves as a strong baseline, offering broad coverage and maximizing recall by not missing potentially relevant data.

In some embodiments, to enhance the contextual relevance of the search results, the retrieval unit 205 may also perform a vector search using machine learning embeddings. The retrieval unit 205 may convert the user query into high-dimensional vectors that capture semantic meaning, as described above. The retrieval unit 205 may then compare the “meaning” of the user query with the meaning embedded in each document, for example, by calculating the similarity of the query with the previously calculated embedding of each document. In some embodiments, to find similarity, a dot product or cartesian product calculation may be used. Dot product is a mathematical operation used to measure the similarity between two vectors. Cartesian product is a mathematical operation used in set theory and databases. In the context of similarity determination here, it may refer to evaluating all possible combinations of query parameters and data entries when filtering or matching features. In some embodiments, by finding the similarity between the embeddings, the system may retrieve documents (such as product datasheets) that are semantically related to the user query, even if they do not contain the exact terms used in the query. This method is particularly powerful because it can retrieve documents that use different wording or terminology to express the same idea, which a keyword-only search might miss.

In some embodiments, the retrieval unit 205 may use a natural language-to-SQL translation, powered by advanced language models like Claude® 3 Opus or custom fine-tuned open-source models. For example, when a user enters a precise question, such as asking for all GPUs with more than 8 GB of memory and less than 300 W power consumption, the retrieval unit 205 may interpret the query and generate a corresponding SQL statement. The retrieval unit 205 may then run this query (i.e., the SQL statement) directly on the relational database, extracting only the records that meet the exact criteria. This approach offers high precision and is ideal for structured queries that depend on specific numerical or categorical values.

In some embodiments, the retrieval unit 205 may use a fine-tuned model specifically trained for the task of converting natural language into SQL queries. For specific training of the fine-tuned model, it may involve taking an open-source LLM and further training it on a dataset composed of domain-specific examples, pairs of user queries, and their corresponding SQL translations, tailored to the structure and schema of the database in use. By doing this, the LLM model learns the nuances of the database's schema, common query patterns, and industry-specific terminology, enabling it to generate more accurate and context-aware SQL queries. This customization then ensures that the retrieval unit 205 can handle complex or ambiguous user queries with higher precision, ultimately improving the effectiveness of structured data retrieval.

Together, these three search techniques form a robust and flexible search framework. The full-text search ensures coverage of documents where terms explicitly appear, the vector search captures semantically related content regardless of wording, and the SQL search retrieves precise, structured matches from the database. By combining all three, the retrieval unit 205 may maximize both recall (i.e., finding all relevant data) and precision (i.e., returning the most relevant results), offering a powerful solution for querying complex technical datasheets.

In some embodiments, the retrieval unit 205 may be equipped with an additional verification mechanism configured to maximize the precision of search results by identifying and filtering out false positives, e.g., documents that may have been incorrectly marked as relevant. While the retrieval unit's multi-method search (full-text, vector, and SQL-based) casts a wide net to ensure comprehensive recall, there is still a possibility that some documents might appear relevant based on keywords or semantic similarity, but do not actually meet the user's intent or criteria. To address this, the retrieval unit 205 may implement a two-step verification process leveraging the power of advanced language models like GPT-4®.

Specifically, once documents are retrieved, the retrieval unit 205 may further extract the relevant fields (such as product specifications or descriptions) and send them, along with the user's original query, to a fine-tuned model, GPT-4® or similar model via an API. The model may be prompted to generate a justification explaining why the retrieved document satisfies the user's query. In some embodiments, the model may further include or eliminate proper parts from the results besides generating the justification. This justification isn't just a summary, it reflects logical reasoning and contextual understanding of the match. In some embodiments, this generated justification may be passed back to GPT-4® with a new or modified prompt, instructing the model to critically evaluate the justification itself and determine its validity. This second layer of evaluation may help confirm whether the match is strong enough to be included in the final result set. The process not only improves the accuracy of the results but also increases trust in the system's outputs. In some embodiments, the retrieval unit 205 may further enhance the verification mechanism by fine-tuning domain-specific models to classify documents as relevant or irrelevant, and potentially even re-rank results based on how confidently they match the user query, leading to smarter, more refined search experiences. The re-ranking may be achieved by using a specifically configured re-ranker coupled with the RAG pipeline, which then allows to eliminate certain datasheets that may not have a high score for the user's query.

Referring continuously to FIG. 2, the AI-driven natural language search application 107 may further include a generation, recommendation and justification unit 207 configured to present the retrieved results with certain recommendations and justifications. For example, after the correct set of products is retrieved by the retrieval unit 205, the generation, recommendation and justification unit 207 may present the retrieved results as recommendations. Using retrieved products as an example, each recommended product may include a key identifier, such as the model name and number.

In some embodiments, along with the key identifier for a recommended product, the generation, recommendation and justification unit 207 may further generate or present a justification for why the product is relevant and thus is retrieved. This explanation is not only important for transparency but also enhances user trust and decision-making clarity. By providing a natural language explanation of how each product matches the query, based on the earlier verification step or generated anew using GPT-4®, the generation, recommendation and justification unit 207 may ensure users understand the relevance without needing to analyze the entire datasheet themselves

In some embodiments, to further enhance user experience, the generation, recommendation and justification unit 207 may use GPT-4® or a similar language model to generate a concise summary that highlights the alignment between the product's specifications and the user's requirements. These summaries may be generated based on the justification described above and may serve as quick insights, enabling users to quickly scan and compare multiple products, especially when they are short on time or need to make fast decisions. In addition, the disclosed system 100 may be configured to further support comparative evaluation, for example, by generating a user interface where users can select two or more datasheets to compare specifications side-by-side, a helpful tool for choosing between similar models or brands.

In some embodiments, the disclosed system 100 may also support interactive exploration of datasheets through a chat-based interface. Specifically, the generation, recommendation and justification unit 207 may explore a RAG approach, which combines the power of a retrieval model to fetch relevant pieces of information with a generative model to produce human-readable responses. With RAG, users may “chat” directly with the content of a datasheet, e.g., asking complex questions, like “what is the thermal design power of this model?” or “does this GPU support PCIe 4.0?”, and get informed, contextual responses not just from the text, but also from images, tables, and diagrams contained in the document. In some embodiments, RAG may be implemented to improve the relevance of a search experience by adding context from additional data sources and supplementing an LLM's original knowledge base. Additional information sources may range from new information on the internet that the LLM wasn't trained on, to proprietary business context, or confidential internal documents belonging to businesses.

In some embodiments, in the RAG implementation for depth (datasheet) search for a recommended product in the present disclosure, each datasheet may contain one or more graphs and/or images that can be enabled to search on. Since each page has a logical start and end in most of these datasheets and since chunking a big document is one the major factors to determine the accuracy and the quality of the response, each datasheet for a specific product may be broken into logical sections, for example, by page. Each page may be then converted into an image which is fed into a proprietary algorithm, which may include a fine-tuned you-only-look-once (Y OLO) model to determine if the page contains an image/block diagram, text, or table. If the page contains an image/block diagram, then it can be fed into Anthropic's Vision API to extract textual information on any graphs or images in it. The remaining text and tables from the page may be further extracted using PDF parsing libraries in combination with Azure's Document AI for extracting table structure. In some embodiments, instead of performing the above process during the extraction phase, the similar phase may be performed in real time when the user asks a query.

In some embodiments, the output of the Vision API for images and diagrams along with the remaining textual information may be then input into a real-time data platform such as Redis in the form of vector embeddings. These vector embeddings may be generated using GPT-4® or the like or specifically configured proprietary embeddings fine-tuned for the industry and domain. Through the lens of vector embeddings, the generation, recommendation and justification unit 207 doesn't just see a picture, it sees a collection of features and patterns, represented as vectors. This becomes particularly powerful when the computer needs to recognize objects in images that vary widely in size, angle, or even lighting conditions. Accordingly, by turning images and graphs included in the datasheet into vector embeddings, a machine learning model can “understand” the features and patterns and perform a task that requires a nuanced understanding of the content. This then helps answer questions not only based on the textual content in the datasheet but also from the images and graphs included in the datasheet when “chatting” with the content of the datasheet.

Referring back to FIG. 2, in some embodiments, the AI-driven natural language search application 107 may include additional units or components not described above. For example, an additional feedback mechanism may be implemented in the AI-driven natural language search application 107, among other possible units or components described elsewhere in the disclosure.

### Specific Implementations

In the following, some implementations of the disclosed AI-driven natural language search application 107 are further described with reference to specific examples.

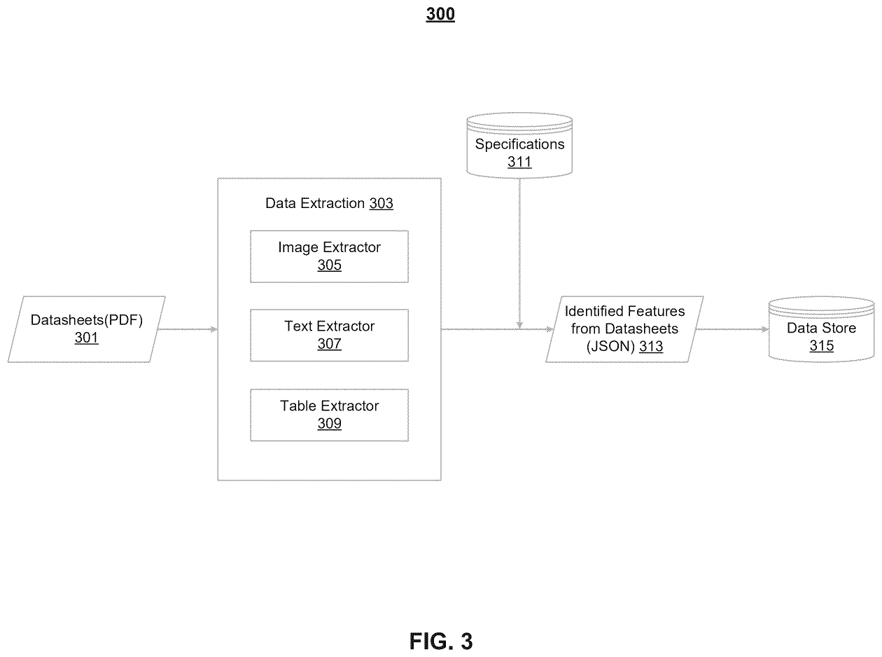

FIG. 3 illustrates an example conceptual flow diagram 300 that outlines a process for extracting structured data from technical documents, in accordance with some embodiments. It is to be noted that, while the figure specifically illustrates the workflow using a PDF-format datasheet, the same process is flexible and adaptable to a wide range of document types, including but not limited to instruction manuals, product catalogs, webpages, and other formats of technical literature. This universality ensures that the data extraction system can be deployed across diverse content sources commonly found in engineering, electronics, and industrial domains.

The conceptual flow diagram 300 begins with the initial extraction phase at step 303, where the system ingests the datasheet 301 and applies specialized tools, such as image extractor 305, text extractor 307, and table extractor 309, to extract three primary types of content: text, images, and tables. This modular approach allows each content type to be handled using tools best suited for its structure. For example, Azure® Computer Vision API may be used as an image extractor 305 to detect and extract image content, including diagrams or photos. Azure® Form Recognizer may be used as a text extractor 307 to parse structured and unstructured text blocks, while Azure® AI Document Intelligence may be used as a table extractor 309 to isolate and extract tabular data. These tools are mentioned for illustration and are not restrictive, as other AI-powered or traditional tools may be substituted depending on the deployment environment or domain-specific needs.

Once the raw content is extracted, the system 100 may proceed to a semantic analysis phase where it identifies key features associated with the product described in the datasheet. These features may include critical elements such as “memory size,” “power rating,” “form factor,” “operating temperature,” etc. Advanced AI language models such as OpenAI's GPT-4®, Claude® by Anthropic, or custom fine-tuned models are utilized at this stage. These models may be adept at understanding the contextual meaning of technical content, enabling them to extract not only features but also their associated specifications 311. For instance, from a GPU datasheet, the model may extract the feature “fan speed” and match it with the value “2200 RPM,” forming a structured feature-specification pair (or feature-value, attribute-value pair, key-value pair, and the like).

After this analysis, the results may be organized and saved in a structured JSON file 313, which acts as a standardized container for storing the extracted data. This JSON file 313 may include all the key-value pairs representing features and their specifications 311 in a machine-readable format. In some implementations, this JSON data is further transformed into a relational database format, making it compatible with relational database management systems such as PostgreSQL, MySQL, or SQL Server. This transformation enables efficient querying and indexing, allowing for integration into enterprise search systems, product recommendation engines, or other data-driven platforms.

In summary, the conceptual flow diagram 300 takes a PDF datasheet as input and outputs a comprehensive, structured dataset in JSON format, encapsulating critical product features, specifications, and other technical information. This process is fully automated, driven by AI-enhanced extraction and language understanding tools, and is designed to scale across multiple document formats and industries. The resulting structured data can then be stored (e.g., in the data store 315), searched, and analyzed with much greater efficiency than manually reviewing and interpreting datasheets.

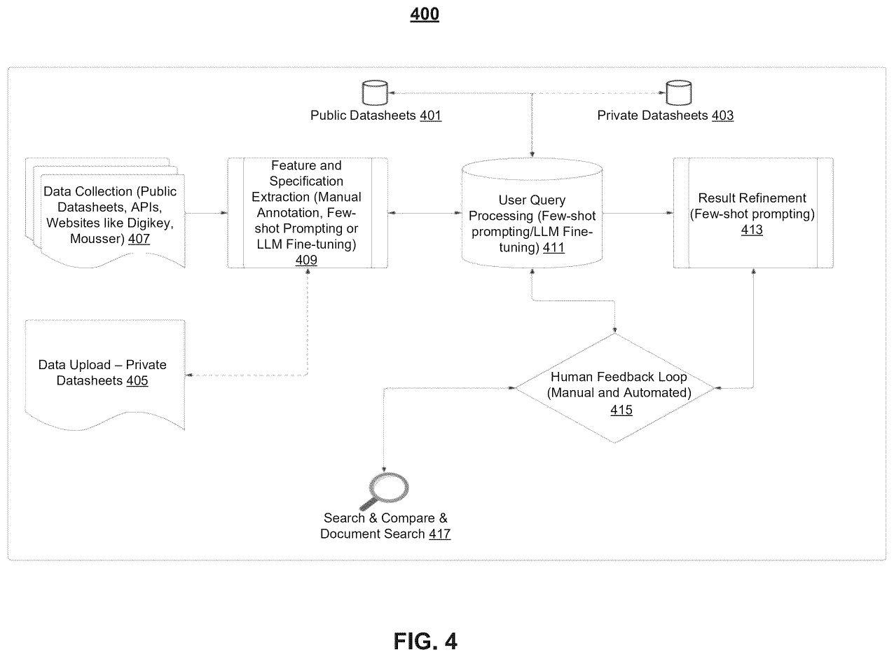

FIG. 4 illustrates an example comprehensive query processing framework 400 designed to intelligently handle user queries, in accordance with some embodiments. The query processing framework 400 may begin with data ingestion for the datasheets from the public datasheets 401 and private datasheets 403. Exemplarily, private datasheets 403 may be uploaded directly through a user-facing upload interface 405. These private datasheets 403 may be internal documents, custom product sheets, or proprietary technical data relevant only within an organization. At the same time, the framework 400 may also conduct automated data collection 407 from public sources, e.g., gather public datasheets 401 from well-known electronic component distributors and platforms such as DigiKey®, Mouser®, and manufacturer A Pls. This combination ensures the datasets are both comprehensive and current, covering both general industry products and user-specific components. Together, these sources 401 and 403 populate the repository used for further processing, such as feature and specification extraction 409.

Specifically, once datasheets are collected from the public and private datasheets, the next crucial step is to extract product-relevant features and specifications from the structures or unstructured documents. This extraction may be accomplished in multiple ways. For example, as shown in block 409 in FIG. 4, more complex or mission-critical data may be extracted in advance (prior to the query and after the collection) through manual annotation to ensure high accuracy. Additionally, or alternatively, for scalable automation, few-shot prompting techniques may be used with large language models, where a model may be guided with a few examples of how to identify features like “input voltage,” “clock speed,” “operating temperature,” etc. Additionally, in more advanced deployments, the models used for extraction may be fine-tuned LLMs trained on domain-specific datasets, enabling these models to understand the technical language and structure of datasheets. Other different techniques described above may be also implemented in the feature and specification extraction 409. In some embodiments, the extracted data including feature-value pairs (e.g., “fan speed: 2200 RPM”) may be further standardized (e.g., converting certain values into correct unit values) and stored for search operations such as in JSON and/or converted into relational databases, which are readily available for user query and system retrieval.

With respect to specific user queries, when a user initiates a search, their query is handled by a sophisticated user query processing engine 411. The user query itself may be expressed in natural language, and this engine 411 may translate natural language questions, like “find all microcontrollers under 1 W with at least 64 KB RAM,” into actionable search tasks. In some embodiments, to improve the understanding and relevance of search responses, the user query processing engine 411 may use few-shot prompting or fine-tuned LLMs to understand the context and convert the query into structured formats such as SQL commands, embedding vectors, or other internal representations suitable for searching different types of data (structured tables, full-text content, or semantic content). Using these various natural language processing tools, the user query processing engine 411 may understand not just the keywords, but also the intent and conditions embedded in the query, which is vital in technical searches.

In some embodiments, once the user query is interpreted through different language models described above, a search against the relational databases (or other processed databases) is executed based on the processed user query. In some embodiments, to maximize coverage and accuracy, a multi-method search across the internal knowledge base is implemented. For example, the user query processing engine 411 may implement multiple search strategies, including but not limited to full-text search (which matches exact words), column-based search (searching structured database fields), and vector search (semantic matching using AI-generated embeddings). The results may include complete datasheets, relevant sections of text from the datasheets (e.g., by page or other different chunks), extracted feature tables, or product summaries. In some embodiments, the results even merely include the relevant sections of text from the datasheets without necessarily including the complete datasheets.

In some embodiments, the query processing framework 400 may include a result refinement stage 413, which focuses on verification and precision enhancement, ensuring that the products returned are truly relevant to the user's intent. In some embodiments, the system 100 uses few-shot prompting techniques or custom-trained models to evaluate the accuracy of the results. The goal is to eliminate false positives, documents that may technically match keywords but don't truly satisfy the user's intent. In some embodiments, for each product retrieved, the system 100 may attempt to generate a justification, using an LLM like GPT-4®, which is capable of generating logical, readable justifications based on both the user query and the retrieved specifications. For example, the model may explain how and why a selected product meets the user's criteria. This then ensures the user receives not only relevant results but also transparent reasoning behind each suggestion. In some embodiments, if a strong justification cannot be formed, that result may be discarded, to minimize false positives and improve overall precision.

In some embodiments, after the refined results are presented, the query processing framework 400 may support a human feedback loop 415. For example, users may approve or reject the recommended products based on their relevance, which helps improve the model's accuracy over time, especially if this feedback is used to retrain or fine-tune the underlying models.

Additionally, users may have the ability to compare multiple datasheets side by side at 417, allowing for deeper comparative analysis before making a decision. For example, two GPUs with similar specs might be displayed together, highlighting differences in memory type or power draw. Furthermore, users may choose to interact more deeply with a specific datasheet using a chat-based interface 417, allowing them to ask contextual questions about the product, like “does this component meet IP67 standards?” or “what is the max supported voltage?” without needing to manually browse through technical jargon.

Overall, FIG. 4 depicts a robust and interactive search and recommendation process that combines AI-driven understanding with human judgment. It spans the full lifecycle of query handling, from intelligent interpretation and multi-layered search, to result validation and user interaction. By blending automated intelligence, natural language processing, and user feedback, the system 100 provides a rich, adaptive experience that significantly simplifies how users explore and assess complex technical products.

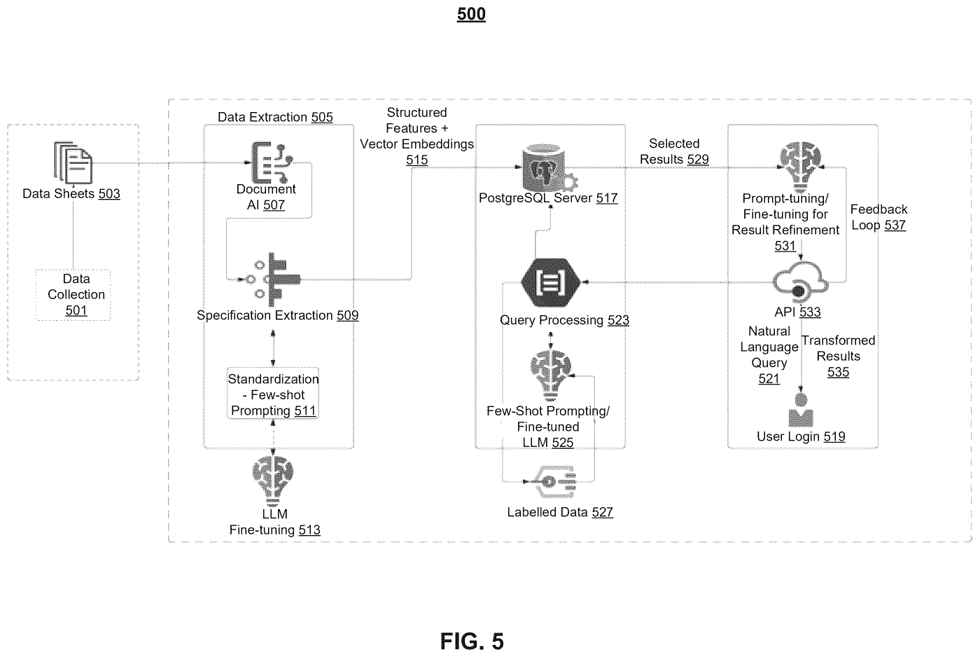

Referring now to FIG. 5, an example conceptual flow diagram 500 for handling a user query is further illustrated, in accordance with some embodiments. The high-level flow diagram 500 outlines an end-to-end data processing process, starting from datasheet collection and ending with refined search results presented to the user. Compared to FIG. 4, the flow diagram 500 in

FIG. 5 emphasizes the role of AI models, prompt engineering, and feedback loops in improving query interpretation and product recommendation quality.

As can be seen from FIG. 5, the process may similarly include a data collection process 501, which is the foundational step where the system gathers raw input data, namely, technical datasheets 503. These datasheets may come from public sources (e.g., component manufacturer websites, and electronics marketplaces like DigiKey®, and Mouser®) and from private uploads from users or internal systems. The collected documents may be in PDF or HTML format, and they contain structured (tables) and unstructured (paragraphs, diagrams) data. This variety makes the next steps necessary to standardize and extract meaning from these complex documents.

The next process in the flow diagram 500 is the data extraction 505, where, once collected, the datasheets 503 are processed by AI-powered document parsing tools 507. An example tool is Azure® AI Document Intelligence, which may identify tables, headers, and paragraphs, segment and classify content, and extract raw feature text (e.g., “operating temperature: −40° C. to +85° C.”). This step is critical because it transforms visual layouts and text blocks into machine-readable components, enabling downstream AI models to understand and manipulate the content.

In some embodiments, the data extraction 505 may further include the specification extraction 509 and standardization 511. Briefly, the extracted content may undergo semantic interpretation. For example, AI models may be used to parse phrases and classify them into feature-specification pairs (e.g., “clock speed→3.4 GHz”) in specification extraction. This stage also involves data standardization, ensuring that terms are normalized (e.g., “GHz” vs “Gigahertz” or a conversion from M Hz to GHz considering GHz is the standardized unit of measurement) and consistent across datasheets from different vendors. Few-shot prompting with function tooling may help guide models by showing a few labeled examples. In some embodiments, fine-tuned LLMs 513 are further used for greater accuracy, trained specifically on technical documentation.

In some embodiments, the standardized data may be then formatted into structured records 515, often stored as JSON objects or relational entries. These are inserted into a PostgreSQL server 517, which is used for efficient querying via SQL, relational linking between products, features, and datasheets, and indexing for search optimization. This structured database becomes the searchable backend that powers user queries.

For handling a user query, a user may be requested to log into the system at 519, according to some embodiments. In some embodiments, a user may also submit a query without logging into the system, which is not limited in the present disclosure. The user query may be a natural language query 521, such as “find all low-power microcontrollers with more than 64 KB RAM,” “show me temperature sensors with analog output.” These queries are informal, flexible, and human-like, requiring the system to translate them into formal queries (like SQL) that match the database structure.

In the next stage of query processing 523, to understand and convert the user's query, the system may use few-shot prompting 525 to provide sample query-response pairs to guide the AI or use fine-tuned LLMs 525 trained in electronics or engineering-specific language. In some embodiments, labeled data 527 such as historical examples of successful queries and outcomes may be used to improve model accuracy. The result is a context-aware SQL query or vector-based semantic search that retrieves highly relevant matches 529 from the database.

In some embodiments, before showing the results, the system may apply a refinement layer 531. For example, LLMs may be prompted to generate a short justification for each result (e.g., “this product matches your query because it offers 8 GB RAM and 1.2 W power usage.”). If the model cannot justify the result, it is considered a false positive and removed. This accordingly creates a high-precision result set with transparent reasoning.

In some embodiments, the refined results are passed through an API layer 533. This may ensure modular access to data from different parts of the system 100 and also support microservices architecture for scalability. In some embodiments, transformation logic is applied to format the results for the UI, such as adding highlights, annotations, or visual context. These transformed results 535 are what the user ultimately sees on their interface.

In some embodiments, once the results are displayed, the system 100 may enable user interactions. For example, users may approve, reject, or comment on individual product suggestions. Users may also compare datasheets, interact with chat-based tools, or ask follow-up questions (e.g., “does this sensor support SPI?”). All feedback, manual or behavioral may be captured and fed back into the system to improve future accuracy, helping the models adapt to real-world usage. This feedback loop 537 thus turns the system 100 into a self-learning platform, improving with each interaction.

### Example Method

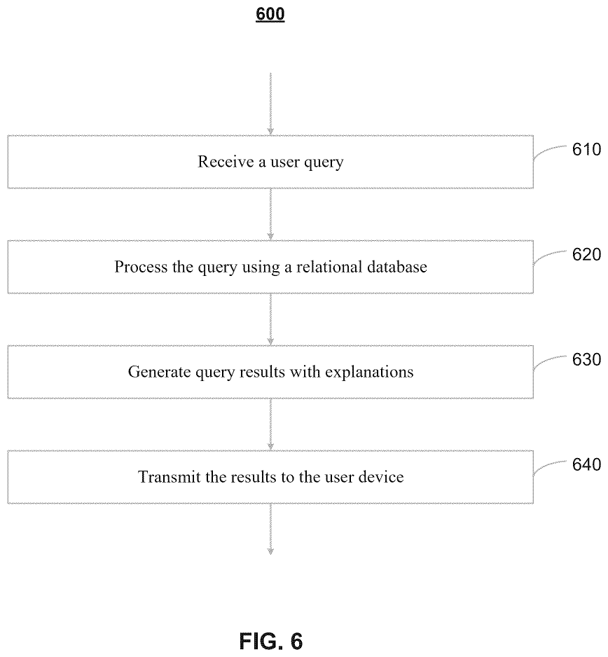

Referring to FIG. 6, an example method 600 for augmented component search utilizing structured and unstructured datasheet data is further illustrated, in accordance with some embodiments.

Step 610: Receive a user query.

The method 600 begins when a user submits a natural language query through an interface on their device. This query may request information about one or more items, such as technical components or products. The system captures this input and prepares it for semantic interpretation, understanding not just the keywords but also the intent behind the query, such as specific features, performance criteria, or usage scenarios.

Step 620: Process the query using a relational database.

Next, the system processes the user query by executing a search against a relational database. This database is not a generic dataset but rather has been specifically constructed by extracting features and identifying specifications from a wide range of product datasheets. These datasheets are parsed using AI tools to create structured data entries, where each item is defined by its attributes and associated values. This structured format may enable precise matching between the query parameters and the available item records.

Step 630: Generate query results with explanations.

Once the database search is complete, the system may compile the query results, and identify one or more items that best match the user's request. Importantly, for each result, the system may also generate a concise summary or justification, especially for cases where an item only partially matches the query or may seem irrelevant. This explanation enhances transparency by helping users understand why a particular item was included or how closely it aligns with their original search intent.

Step 640: Transmit the results to the user device.

Further, the system may transmit the processed results, including both the matching items and their associated relevance summaries, to the user's device for presentation. The user may receive a clear, ranked list of suggestions, each with a brief context explaining its selection. This structured and explainable output empowers users to make informed decisions, improving both usability and trust in the system's recommendations.

The advantages of the method and system disclosed herein may include but are not limited to enhanced search accuracy, context-aware and explainable results, efficient data utilization (e.g., the system leverages AI models (e.g., LLMs, few-shot prompting) to automatically extract and standardize features from complex datasheets), improved user experience (e.g., optional chatting, comparison, and feedback loops further enhance engagement and usability), adaptive and self-improving (e.g., through a built-in feedback loop), time and cost efficiency (e.g., by automating both data extraction and query handling, the method significantly reduces the time and labor required to analyze datasheets and retrieve relevant product information), etc.

### Additional Embodiments

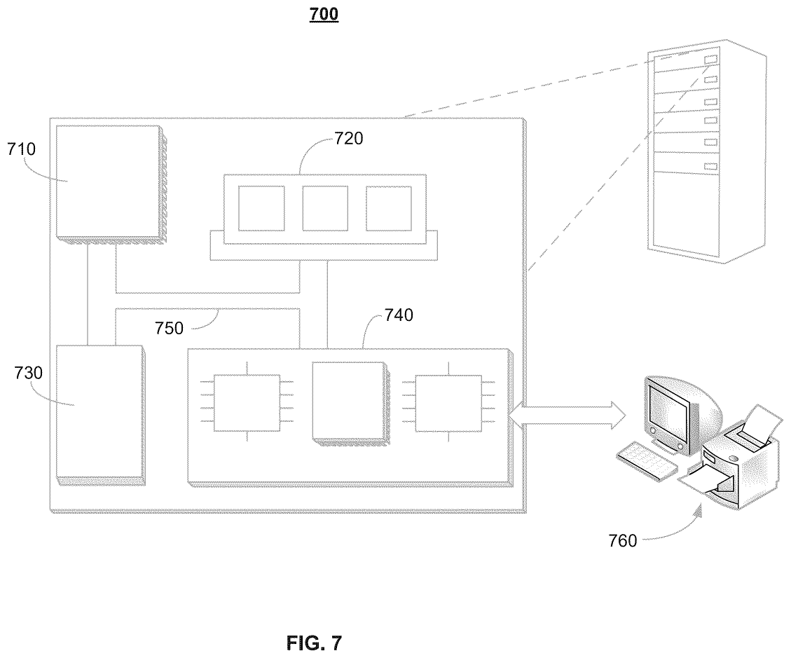

FIG. 7 is a block diagram of an example computer system 700 that may be used in implementing the technology described in this document. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. In some implementations, the processor 710 is a programmable (or reprogrammable) general-purpose microprocessor or microcontroller. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large-capacity storage devices. For example, the storage device may store long-term data (e.g., database data, file system data, etc.). The input/output device 740 provides input/output operations for the system 700. In some implementations, the input/output device 740 may include one or more network interface devices, e.g., an Ethernet card, a serial communication device, e.g., an RS-232 port, and/or a wireless interface device, e.g., an 802.10 card, a 3G wireless modem, or a 4G wireless modem. In some implementations, the input/output device may include driver devices configured to receive input data and send output data to other input/output devices, e.g., keyboard, printer, and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer-readable medium. The storage device 730 may be implemented in a distributed way over a network, for example as a server farm or a set of widely distributed servers, or may be implemented in a single computing device.

Although an example processing system has been described in FIG. 7, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., a Field Programmable Gate Array (FPGA), an Application Specific Integrated Circuit (ASIC), or a programmable general-purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto-optical disks, or optical disks. However, a computer need not have such devices. Moreover, a computer can be embedded in another device, e.g., a mobile telephone, a Personal Digital Assistant (PDA), a mobile audio or video player, a game console, a Global Positioning System (GPS) receiver, or a portable storage device (e.g., a Universal Serial Bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a Cathode Ray Tube (CRT) or Liquid Crystal Display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a Local Area Network (LAN) and a Wide Area Network (WAN), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROM s and holographic devices; magneto-optical media; and hardware devices that are specially configured to store or to store and execute program code, such as ASICs, Programmable Logic Devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROM s and holographic devices; magneto-optical media; and hardware devices that are specially configured to store or to store and execute program code, such as ASICs, PLDs, flash memory devices, and ROM and RAM devices. Examples of computer code include machine code, such as produced by a compiler, and files containing higher-level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

In embodiments, aspects of the techniques described herein (e.g., training a risk assessment model, using a risk assessment model to assess the risk associated with a commit request, performing one or more (e.g., all) of the steps of the methods described herein, etc.) may be implemented using machine learning and/or artificial intelligence technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. A value of a feature may be a measurement of the corresponding property of an entity or an instance of information regarding an entity. Features can also have data types. For instance, a feature can have an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “model” may refer to any suitable model artifact generated by the process of using a machine learning algorithm to fit a model to a specific training data set. The terms “model,” “data analytics model,” “machine learning model” and “machine-learned model” are used interchangeably herein.

As used herein, the “development” of a machine learning model may refer to the construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

As used herein, “data analytics” may refer to the process of analyzing data (e.g., using machine learning models, artificial intelligence, models, or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

Data analytics tools are used to guide decision-making and/or to control systems in a wide variety of fields and industries, e.g., security; transportation; risk assessment and management; supply chain logistics; and energy management. The processes used to develop data analytics tools suitable for carrying out specific data analytics tasks generally include steps of data collection, data preparation, feature engineering, model generation, and/or model deployment.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the disclosure and may be in more than one embodiment. Also, the appearance of the above-noted phrases in various places in the specification does not necessarily refer to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided to, or steps or stages may be eliminated from, the described processes. Accordingly, other implementations are within the scope of the following claims.

It will be appreciated by those skilled in the art that the preceding examples and embodiments are exemplary and not limiting the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this disclosure, it is to be appreciated that various alterations, modifications, and improvements will readily occur to those skilled in the art. Such alterations, modifications, and improvements are intended to be part of this disclosure and are intended to be within the spirit and scope of the disclosure. Accordingly, the foregoing description and drawings are by way of example only.

What is claimed is:

1. A computer-implemented method, comprising:
receiving a user query for one or more items from a user;
processing the user query by searching against at least one relational database associated with the query, wherein the relational database is generated by extracting features from electronic documents of a plurality of items associated with the one or more items and by identifying specifications or respective values corresponding to the extracted features of the plurality of items;
generating one or more query results based on the processing of the user query, wherein the one or more results include at least one item identified from the plurality of items and a justification for explaining an irrelevance of the at least one item; and
transmitting the one or more query results to a user device for presentation to the user.

2. The method according to claim 1, wherein processing the user query further includes an extraction process where a PDF file or a website containing electronic document information is taken as an input and a structured JSON file containing comprehensive extracted data is produced as an output.

3. The method according to claim 2, wherein the extraction process is automated by fine-tuning a multimodal large language model with reinforcement learning with human feedback.

4. The method according to claim 1, wherein the user query is a natural language user query, and processing the user query further includes converting the natural language user query into high-dimensional vectors that capture semantic meaning of the user query.

5. The method according to claim 4, wherein extracting the features from the electronic documents further includes converting one or more paragraphs and tables from an electronic document into vector embeddings.

6. The method according to claim 5, wherein generating the one or more query results further includes implementing a vector-based semantic search to determine a similarity between the vector embeddings associated with the electronic document and the high-dimensional vectors associated with the user query.

7. The method according to claim 6, wherein the similarity between the vector embeddings associated with the electronic document and the high-dimensional vectors associated with the user query is determined by using a dot product or a cartesian product calculation.

8. The method according to claim 1, wherein searching against the at least one relational database includes implementing a multi-method search, wherein the multi-method search includes a full-text-based search, a vector-based search, and an SQL-based search.

9. The method according to claim 1, wherein presenting the one or more query results to the user further includes generating a chat-based user interface to allow the user to ask contextual questions about the at least one item included in the one or more query results.

10. The method according to claim 9, wherein the chat-based user interface is generated based on a retrieval-augmented generation (RAG) approach.

11. The method according to claim 10, wherein, when generating the chat-based user interface based on the RAG approach, an electronic document for an item included in the one or more query results is broken into pages, wherein each page is then converted into an image which is fed into a proprietary algorithm to determine if the page contains an image or block diagram, text or table.

12. The method according to claim 11, wherein, when the page contains an image or block diagram, the page is fed into an API to extract textual information included in the image or block diagram.

13. The method according to claim 12, wherein remaining text or table from the page is extracted using PDF parsing libraries in combination with an artificial intelligence (AI) tool for extracting table structure.

14. The method according to claim 11, wherein the proprietary algorithm is a fine-tuned you-only-look-once (Y OLO) model.

15. The method according to claim 1, wherein presenting the one or more query results to the user further includes generating a user interface to allow the user to compare two or more items included in the one or more query results.

16. The method according to claim 15, wherein the user interface is generated based on JSON files converted from electronic documents associated with the two or more items.

17. The method according to claim 1, wherein generating the one or more query results based on the processing of the user query further includes excluding an item from the one or more query results when a justification for the item is unable to be generated.

18. The method according to claim 1, wherein the justification is generated by using a multimodal large language model, and the generated justification is further passed back to the multimodal large language model with a new or modified prompt, instructing the multimodal large language model to evaluate the justification itself and determine a validity of the justification.

19. A system for AI-driven natural language search, comprising:
a processor; and
a memory coupled to the processor, and the memory storing executable instructions that, when executed by the processor, cause the processor to:
receive a user query for one or more items from a user;
process the user query by searching against at least one relational database associated with the query, wherein the relational database is generated by extracting features from electronic documents of a plurality of items associated with the one or more items and by identifying specifications or respective values corresponding to the extracted features of the plurality of items;
generate one or more query results based on the processing of the user query, wherein the one or more results include at least one item identified from the plurality of items and a justification for explaining an irrelevance of the at least one item; and
transmit the one or more query results to a user device for presentation to the user.

20. A non-transitory computer-readable medium storing instructions that, when executed by a processor, cause the processor to perform a method for AI-driven natural language search, the method comprising:
receiving a user query for one or more items from a user;
processing the user query by searching against at least one relational database associated with the query, wherein the relational database is generated by extracting features from electronic documents of a plurality of items associated with the one or more items and by identifying specifications or respective values corresponding to the extracted features of the plurality of items;
generating one or more query results based on the processing of the user query, wherein the one or more results include at least one item identified from the plurality of items and a justification for explaining an irrelevance of the at least one item; and
transmitting the one or more query results to a user device for presentation to the user.
